(19) United States
(12) Patent Application Publication
(10) Pub. No.: US 2015/0156528 A1
(43) Pub. Date: Jun. 4, 2015

(54) MULTI-SCREEN SERVICE PLATFORM FOR SUPPORTING A DIGITAL BROADCASTING TV NETWORK

(71) Applicant: Alcatel Lucent, Boulogne Billancourt (FR)

(72) Inventors: Chilin Xu, Shanghai (CN); Nan Wang, Shanghai (CN)

(73) Assignee: Alcatel Lucent, Boulogne Billancourt (FR)

(21) Appl. No.: 14/415,274

(22) PCT Filed: Jun. 21, 2013
(86) PCT No.: PCT/IB2013/001717

§ 371 Date: Jan. 16, 2015

(30) Foreign Application Priority Data
Jul. 18, 2012 (CN) 201210249359.3

(51) Int. Cl. H04N 21/2665; H04N 21/258; H04N 21/61; H04N 21/41; H04N 21/433; H04N 21/472; H04H 20/24; H04N 21/2662

(52) U.S. Cl. CPC H04N 21/2665; H04H 20/24; H04N 21/25825; H04N 21/2662; H04N 21/4122; H04N 21/4126; H04N 21/4334; H04N 21/47217; H04N 21/6112; H04N 21/6131; H04N 21/6181

(57) ABSTRACT

The present invention relates to a mobile phone used in a multi-screen service system comprising a digital broadcasting TV network and a cellular mobile communication network, the mobile phone is connected to the digital broadcasting TV network and the cellular mobile communication network, said mobile phone comprises: detecting module, configured to detect if there is another display with valid connection, when receiving common definition video content through the digital broadcasting TV network or the cellular mobile communication network; and switching module, in case another display with a valid connection is detected, configured to switch said common definition video to a higher definition video having the same video content if the higher definition video corresponding to the common definition video exists and play the higher definition version of the video content on said another display, and configured to play said common definition video on said another display if on higher definition video corresponding to the common definition video exists.

### TECHNICAL FIELD

The present invention relates to a multi-screen service, in particular a multi-screen service platform for supporting a digital broadcasting TV network.

### DESCRIPTION OF THE RELATED ART

Currently, multi-screen (Cell-phone, PC and TV, with unified multimedia content and management platform) service subscribers increase sharply and multiple indicators are foretelling that multi-screen content delivery will be the next mega-trend for broadband services for telecom operators and service providers.

However, beside PCs and TVs, current multi-screen service platforms can only support single mode cell-phones which receive video data from Cellular Mobile Communication Network (e.g., 3G/LTE/4G Cellular Network). The high bandwidth need of video service brings a great challenge to cellular mobile communication network which is short of radio spectral resource. Moreover, using a cellular mobile communication network to deliver video data to a cell-phone is too expensive for common users and it will bring a huge traffic and resource burden to the cellular mobile communication network.

On the contrary, digital broadcasting TV handheld terminals (e.g., DVB-H handheld terminal in Europe, MediaFLO handheld terminal in USA as well as DMB handheld terminal in South Korea and broadcasting television network CMMB handheld terminal in China) only use broadcasting television frequency bands (TV broadcast bands) to receive video data broadcasted in a one-way broadcasting way. Therefore, it can be envisaged, if digital broadcasting TV handheld terminals are used to perform video reception of current multi-screen services, radio spectral resources of the cellular communication network will be greatly saved.

However, so far, because of the one-way broadcasting way of the digital broadcasting TV network (which belongs to the broadcasting television network, namely, TV broadcasting network, and uses TV broadcast bands), existing multi-screen service platforms cannot support digital broadcasting TV handheld terminals. How to implement multi-screen functions and interactive functions using broadcasting TV mode handheld terminals is an urgent problem to be solved.

### SUMMARY OF THE INVENTION

The main purpose of the invention is to establish a new multi-screen service platform, which can provide a variety of typical multi-screen services to users of digital broadcasting TV Handheld terminals. The invention is based on a digital broadcasting television and a mobile phone, which mobile phone can support both a digital broadcasting TV network and a cellular mobile communication network simultaneously. Obviously, the cellular mobile communication network may provide basic communication functions to this kind of cell-phone (voice and short message SMS), and the digital broadcasting TV network supplies video data to this kind of cell-phone on broadcasting television frequency band in a one-way broadcasting television mode. In the present invention, the use of dual-mode mobile phone may implement multi-screen function on the multi-screen service platform, and the description will be given below by example of the following three functions: 1) Multi-screen Bookmark and Re-playing time remind; 2) Self-adaptive video definition adjustment for different multi-screen terminals; 3) Cross-screen video recording.

On one hand, the invention provides a mobile phone used in a multi-screen service system comprising a digital broadcasting TV network and a cellular mobile communication network, the mobile phone is connected to the digital broadcasting TV network and the cellular mobile communication network, said mobile phone comprising: detecting module, configured to detect if there is a physical connection (such as HDMI connection, or Wi-Fi connection or wireless USB connection or Bluetooth connection) to another display with a higher definition (usually having a bigger screen size), when receiving lower-definition video content through the digital broadcasting TV network; and switching module, configured to, if the presence of a valid connection with another display is detected, switch broadcasting television receiving frequency band thereof from a frequency band where the lower-definition video content is to a frequency band where the higher-definition video content is (at the same time, the video contents on the two TV broadcast bands are exactly the same, merely different in definition) and play the higher-definition video content on the another display. Of course, if the digital broadcasting TV network provides only video content of one video definition in the moment, the video content may be directly transmitted and presented on the another display, without frequency band switching.

According to an embodiment of the invention, the detecting module is further configured to detect the presence of another display with one of Wi-Fi, Bluetooth, wireless USB connections. If the presence of another display with one of Wi-Fi, Bluetooth, wireless USB connections is detected, and there is a valid physical connection with a dual-mode handheld terminal, the switching module is further configured to switch the video content to the another display for play.

The multi-screen service system according to the embodiment of the invention comprises a multi-screen server and the mobile phone further comprises an interacting module configured to send a multi-screen bookmark associated with the video content being watched through the cellular mobile communication network to the multi-screen server, the multi-screen bookmark comprising bookmark time and channel number.

According to the embodiment of the invention, the interacting module is further configured to receive an inquiring message for inquiring on which kind of terminal the multi-screen user having the mobile phone wants to watch the rest of the video content.

According to the embodiment of the invention, the interacting module is further configured to receive a reminding message for reminding re-playing time of the rest of the video content on the digital broadcasting TV network or the IPTV network.

According to the embodiment of the invention, the interacting module is configured to send a command to the multi-screen server of recording a multi-screen video content (the video may be from the digital broadcasting TV network and may also be from an IPTV network, and the recording format and video definition may be chosen by the user, namely, may play at any one multi-screen terminal of the user), in order to set and inform beginning-time and end-time of the recorded video content, and the specific recording operation is specifically performed on the multi-screen service platform side (not on the mobile phone side).

On the other hand, the invention provides a method for a multi-screen service operation through a mobile phone in a multi-screen service system comprising a digital broadcasting TV network and a cellular mobile communication network, the mobile phone is connected to the digital broadcasting TV network and the cellular mobile communication network, said method comprising: detecting if there is a physical connection (such as HDMI connection, or Wi-Fi connection or wireless USB connection or Bluetooth connection) to another display with a higher definition (usually having a bigger screen size), when receiving lower-definition video content through the digital broadcasting TV network; and if the presence of another display with a valid physical connection is detected, switching the lower-definition video content to a higher-definition frequency band of the video content and playing and displaying the higher-definition video content on the another display. Of course, if the digital broadcasting TV network provides only video content of one video definition in the moment, the video content may be directly transmitted and presented on the another display, without frequency band switching.

According to the embodiment of the invention, the detecting step is further configured to detect if there is a valid physical connection with another display (with one of Wi-Fi, Bluetooth, wireless USB connections). If the presence of such valid physical connection is detected, the video content is transmitted and presented on the another display for play.

According to the embodiment of the invention, the multi-screen service system comprises a multi-screen service platform (the core element of which is a multi-screen server) and a multi-screen terminal (mobile phone, PC, TV), and the mobile phone further comprises sending a multi-screen bookmark associated with the video content being watched through the cellular mobile communication network to the multi-screen server, the multi-screen bookmark comprising channel number, bookmark time and the like. Here, a multi-screen user having a dual-mode handheld terminal usually uses a dual-mode mobile phone to receive a video content in a digital broadcasting television mode, and to send a bookmark in a cell-phone mode (the moment at which the user interrupts watching the video is recorded), and the moment is the moment at which the multi-screen server receives the bookmark minus delay time of the time period (avoiding inaccurate time of the user mobile phone).

According to the embodiment of the invention, there is further comprised receiving an inquiring message from the multi-screen server for inquiring which kind of terminal the multi-screen user having the mobile phone selects to watch the rest of the video content.

According to the embodiment of the invention, there is further comprised receiving a reminding message from the multi-screen server for reminding re-playing time of the rest of the video content on the digital broadcasting TV network or the IPTV network.

According to the embodiment of the invention, there is further comprised sending a command to the multi-screen server of recording digital broadcasting TV video content in order to set and inform beginning-time and end-time of recording the digital broadcasting TV video content.

The invention further provides a multi-screen server for serving a mobile phone in a multi-screen service system comprising a digital broadcasting TV network, a cellular mobile communication network and an IPTV network, the mobile phone being connected to the digital broadcasting TV network and the cellular mobile communication network, the multi-screen server comprising: a first interacting module configured to, when receiving a multi-screen bookmark associated with the video content being watched sent by the mobile phone via the cellular mobile communication network, send a reminding message or an inquiring message to the mobile phone for reminding re-playing time of the rest of the video content on the digital broadcasting TV network or the IPTV network or for inquiring on which kind of terminal the multi-screen user having the mobile phone wants to watch the rest of the video content; and a second interacting module configured to, receive a command from the mobile phone of recording multi-screen video content, the command being used for setting and informing beginning-time and end-time of recording the multi-screen video content.

In the invention, a variety of existing basic multi-screen features may be implemented using dual-mode handheld terminal, and it is very helpful to improve Quality of Experience (QoE) of the multi-screen service utilizing the digital broadcasting TV network, Internet and IPTV network, for example, the use of multi-screen bookmark of TV broadcast allows the mobile phone user having a dual-mode handheld terminal, when using the dual-mode mobile phone to recover reception of video content, or when switching the display terminal, not to have to start from scratch to watch video but only to watch the rest of the video just from the interrupt (where the bookmark is recorded). In addition, the invention can greatly save the wireless spectral resource of the cellular mobile communication network (not to use the cellular mobile communication network to transmit video content to the multi-screen user as far as possible).

### BRIEF DESCRIPTION OF THE DRAWINGS

Exemplary embodiments may be understood more comprehensively with reference to the detailed description and drawings given below, in which the same element is denoted by the same reference sign, which are given merely for the purpose of description, and in which:

FIG. 1 shows a multi-screen service platform according to an exemplary embodiment of the present invention;

FIG. 2 shows a flow chart for implementing multi-screen bookmark and replaying time reminding operation according to the embodiment of the present invention;

FIG. 3 shows a schematic diagram of multi-screen self-adaptive video definition adjustment according to one embodiment of the invention;

FIG. 4 shows a schematic diagram of cross-screen video recording according to the embodiment of the present invention; and

FIG. 5 shows a schematic structural diagram of a dual-mode mobile phone and a multi-screen server according to the embodiment of the present invention.

### DETAILED DESCRIPTION OF THE PREFERRED EMBODIMENT

A variety of exemplary embodiments are now described more comprehensively with reference to the drawings. It should be pointed out that specific structural and functional details disclosed here are merely to describe the exemplary embodiments. The exemplary embodiments may be embodied through many alternative forms and cannot be regarded merely limited to the embodiments described herein. It may be appreciated that those skilled in the art can envisage a variety of implementations which reflect the principle of the present invention and are included within the range of the present invention listed in the claims and their equivalent forms, although such implementations are not expressly described or shown herein.

In addition, it may be appreciated, although the terms “first”, “second” and the like may be used herein to describe various elements, these elements should not be limited by the terms, because the terms are used merely to distinguish between an element and another element or between a function and another function. For example, without departing from the range of exemplary embodiments, the first element may be called the second element, and similarly, the second element may be called the first element, or the first element and the second element being themselves the same element, are used to distinguish different functions completed by the same element for clear description. In the present application, “dual-mode mobile phone”, “cellular mobile phone supporting the digital broadcasting TV network” and “mobile phone connected to the cellular mobile communication network and digital broadcasting TV network” have similar meanings.

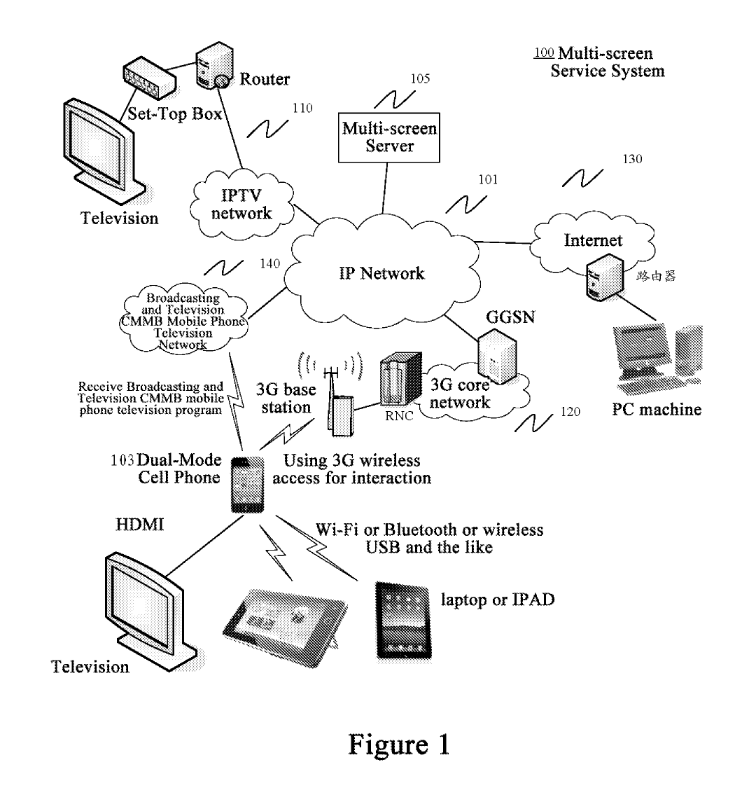

FIG. 1 shows a multi-screen service system 100 according to the basic idea of the invention.

In the multi-screen service system shown in FIG. 1, unlike the prior art, there are four networks which may provide multimedia services: IPTV network 110, mobile communication network 120, the Internet 130 and digital broadcasting TV network 140 (taking CMMB an the example), and a multi-screen server is connected with the four different networks through the IP network 101 and then provides a wide range of multi-screen service functions to multi-screen users through the four different networks.

The IPTV network 110 is used to provide IPTV services to users, and may include for example an IPTV server (not shown), a head end (not shown), a router and an IPTV TV client composed of such as set-top box, TV etc. IPTV content including video, audio and other multimedia data may be provided to the IPTV TV client through the IPTV network. The cellular mobile communication network (which takes 3G network as an example in this figure but is not limited to 3G network, and may be a cellular mobile communication network such as GSM, GPRS, LTE network, etc., as long as it can support short message or SIP protocol or HTTP protocol) 120 is used to provide mobile communication services to users having such as mobile phone, personal digital assistant through a mobile communication network comprising a core network and a base station. The Internet 130 is used to provide digital multimedia services to multi-screen users having terminals like PC through the Internet.

It may be appreciated that the IPTV network 110 may further include other facilities suitable for distributing IPTV contents to TV clients, such as cable, transmitting station, relay station etc. The cellular mobile communication network 120 may further include other facilities suitable for distributing mobile multimedia contents to portable clients, such as antenna, mobile services switching centre, packet data service support node, etc. Similarly, the Internet 130 may further include other facilities suitable for delivering multimedia services to a PC machine client 134, such as router, switch, firewall, packet server, streaming server etc. Since these belong to existing technologies known to those skilled in the art, they are not shown here for conciseness.

It should be noted that a new digital broadcasting TV network 140 is introduced in the multi-screen service system in accordance with the embodiment of the invention, and a dual-mode mobile phone 103 according to the embodiment of the present invention supports both digital broadcasting digital multimedia service and cellular mobile communications network service simultaneously by receiving digital broadcasting TV network (such as CMMB (China Mobile Multimedia Broadcasting) mobile phone TV network in FIG. 1) wireless signal and through an air wireless interface connection with the cellular mobile communication network.

It should be noted additionally that in the present application, the multi-screen service system is mainly composed of a multi-screen service platform, a multi-screen terminal and a video content delivery network, a multi-screen user interaction network, etc. The multi-screen service platform is mainly composed of a multi-screen server, a video and transcoding device, an Authentication, Authorization and Accounting (AAA) server, a portal server, a service guideline server, etc., and when there are not many multi-screen users, the video and transcoding device, the Authentication, Authorization and Accounting (AAA) server, the portal server, and the service guideline server can be implemented by software and are deployed physically on the same server. Since the core element of the multi-screen service platform is the screen server, this server having a variety of functions is also called the multi-screen server, and in this paper, a multi-screen server may also be used to refer to the multi-screen service platform. Of course, if there are many multi-screen users, a mirror server or a server group or a server cluster may also be used, or elements of the multi-screen service platform are each consist of a single server. No matter what specific forms, they should not hinder those skilled in the art from understanding that.

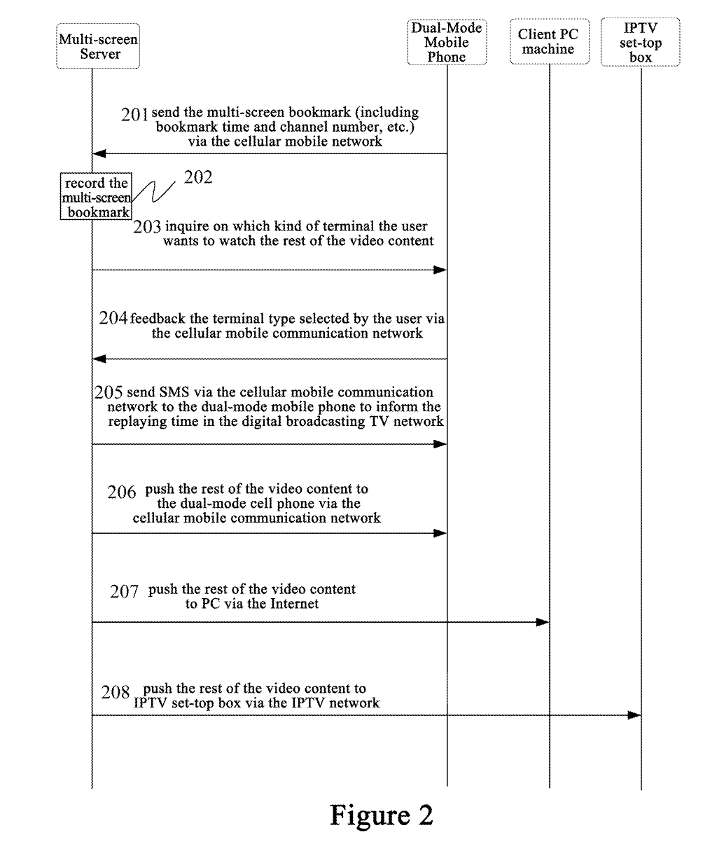

FIG. 2 shows a multi-screen bookmark and replaying time reminding according to one embodiment of the present invention.

In step 201, the multi-screen user sends multi-screen bookmark (including relevant information such as bookmark time and channel number, etc.) via a cellular mobile communication network for example using one SIP signaling or HTTP signaling or a kind of short-cut touch-control screen operation. In step 202, the multi-screen server records the multi-screen bookmark sent by the corresponding user, the multi-screen bookmark including relevant information such as video channel number and bookmark time, etc. In step 203, via the cellular mobile communication network, the multi-screen server uses for example a SMS message to inquire on which kind of terminal the multi-screen user wants to watch the rest of the video content. In step 204, via the cellular mobile communication network, the multi-screen user feedbacks the terminal type selected by the multi-screen user to the multi-screen server.

The rest of the video content may be pushed onto the dual-mode mobile phone, IPTV set-top box or PC terminal based on the feedback of the user. If the cellular mobile communication network does not have enough bandwidth for transmission of video data, it can send a SMS (short message) to remind replaying time of the same video content of the digital broadcasting TV network or IPTV network.

More specifically, the ways in which multi-screen user watches the rest of the video content are listed below:

⊃ If the user selects a dual-mode cell-phone as the terminal to watch the rest of the video content, then via the cellular mobile communication network, the multi-screen server sends a SMS to the dual-mode cell-phone to inform the replaying time of the digital broadcasting TV network to the user (this way is shown in step 205); optionally (if the video content is not replayed in the digital broadcasting TV network), the multi-screen server pushes the rest of the video content to the dual-mode mobile phone via the cellular mobile communication network (this way is shown in step 206).

⊃ If the multi-screen user selects a PC (laptop, iPad, etc.) to watch the rest of the video content, then in step 207 the multi-screen server pushes the rest of the video content to the PC via the Internet.

⊃ If the multi-screen user selects a TV to watch the rest of the video content, then in step 208 the multi-screen server pushes the rest of the video content to the IPTV set-top box of the multi-screen user via the IPTV network.

A person skilled in the art may easily understand that the multi-screen user may select the way to watch the rest of the content on his own initiative considering watching costs, watching convenience and personal preferences, and steps 205-208 are executed in a selective or alternative way. For example, while a multi-screen user is using a mobile phone at a station to watch some common-definition video content through the digital broadcasting TV network, his family may watch a video of the same content having higher definition using a TV at home through the IPTV network simultaneously (both videos having the same content and the same broadcasting time come from a unified multi-screen service platform).

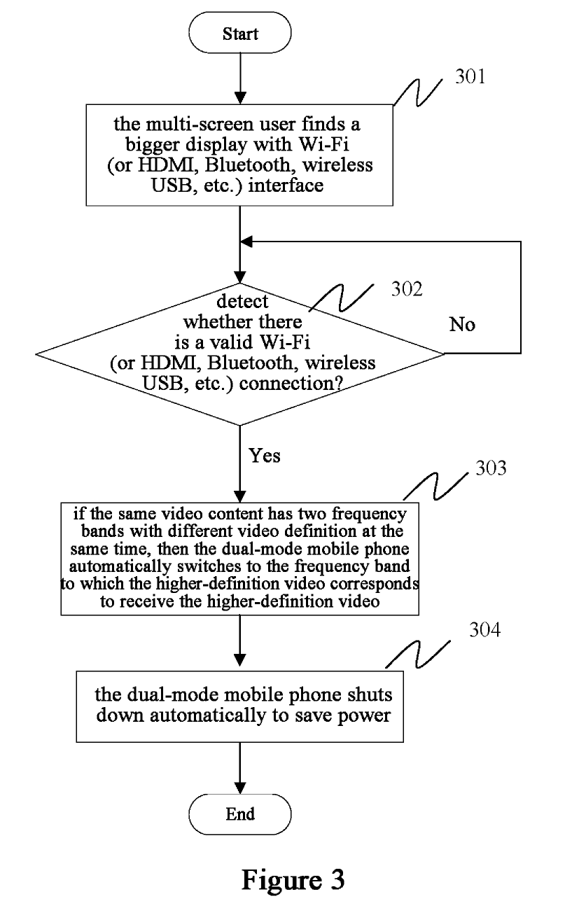

FIG. 3 shows a schematic diagram of self-adaptive video definition adjustment according to one embodiment of the invention.

In step 301 of FIG. 3, according to a preferred embodiment of the invention, the user of the dual-mode mobile phone user finds a bigger screen display with Wi-Fi interface function. The multi-screen user may consider using higher definition to display video on the bigger screen display (for example, television), even in a moving vehicle. Usually, the digital broadcasting TV network will simultaneously broadcast common-definition video and high-definition video (both videos having the same video content) in different radio spectrums (TV broadcast bands). Optionally, in this embodiment, the user of the dual-mode mobile phone user finds a bigger display having a high-definition multimedia interface (called HDMI interface thereafter), Bluetooth, wireless USB, etc., and may consider to use the bigger display with higher definition to display the video, even in a moving vehicle.

In step 302, the dual-mode mobile phone detects the presence of valid Wi-Fi (or HDMI, Bluetooth, wireless USB, etc.) connection. Once having detected the valid Wi-Fi connection or HDMI, Bluetooth, wireless USB connection, etc., then in step 303, through the valid Wi-Fi connection or other valid connection such as HDMI, Bluetooth, wireless USB, etc., the dual-mode mobile telephone will automatically switch to a frequency band to which the higher-definition video corresponds to receive the higher-definition video to fit for the bigger screen. It may be appreciated, when the dual-mode mobile phone receives the video content through Wi-Fi, it is actually equivalent to a broadcast and television signal receiver of the bigger screen display.

Of course, if the video content being broadcasted in the digital broadcasting TV network has only one video definition, then, the dual-mode mobile phone may also switch the video directly to another display for play (not shown), so that the multi-screen user gets better video watching experience and saves electric power of the dual-mode mobile phone.

In step 304, the dual-mode mobile phone will automatically shut off the screen thereof to save electric energy.

With the scheme given in the exemplary embodiment in FIG. 3, once the user of the dual mode cell-phone finds one display with Wi-Fi (or HDMI, Bluetooth, wireless USB) interface at anywhere, he/she can play and display video on the bigger display, even in a moving vehicle.

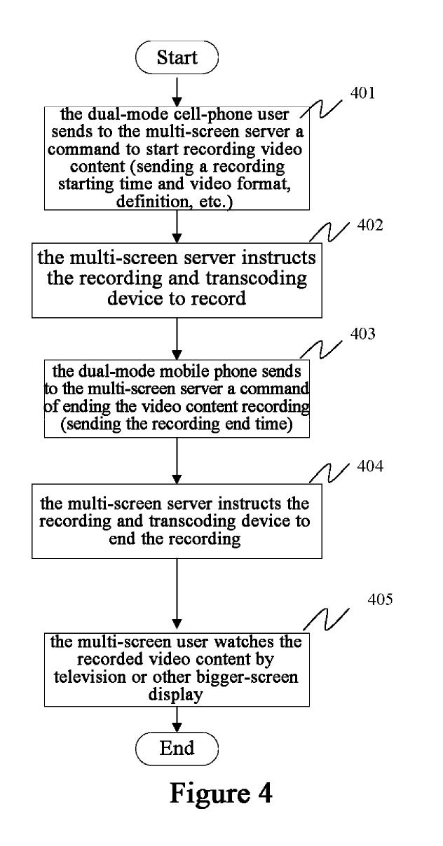

FIG. 4 shows a schematic diagram of cross-screen video recording according to the embodiment of the present invention.

In step 401, with the use of SIP signaling or HTTP signaling or short-cut touch-control screen operation, the dual-mode cell-phone user can send to the multi-screen server a command to record digital broadcasting TV or IPTV video content, and the dual-mode mobile phone sends to the multi-screen server a command to start recording video content, such as sending a recording starting time and video format, definition, etc. No matter where he/she is (even in a moving vehicle).

In step 402, the multi-screen server may instruct the recording and transcoding device (not shown) to record.

Then in response to the instruction, the recording and transcoding device records clips of the multimedia content in the user-desired format according to a request of the user at a given time. The clips of the multimedia content to be recorded may be obtained directly from a storage (not shown) which stores multimedia program source file. The recorded multimedia content fragments are stored in the storage for re-play on the desired platform.

Then, in step 403, the dual-mode mobile phone sends to the multi-screen server a command of ending the video content recording, for example, sending the recording end time.

In step 404, the multi-screen server instructs the recording and transcoding device to end the recording.

Finally, in step 405, the multi-screen user watches the recorded video content by television or other bigger-screen display. In other words, the multi-screen user can relive wonderful parts of the corresponding video on any screen which he can get at any time anywhere, for example, a large LCD television screen at home, in-vehicle television, his own mobile phone when waiting at the station, etc.

In other embodiments of the present invention, using the cross-screen video recording function, a user may make and receive his/her custom-built video at any device with corresponding video definition. For example, a user can record at his/her PC video content as a video clip suitable for play on cell phone and watch this video clip on his/her cell phone in order to enjoy it at any time.

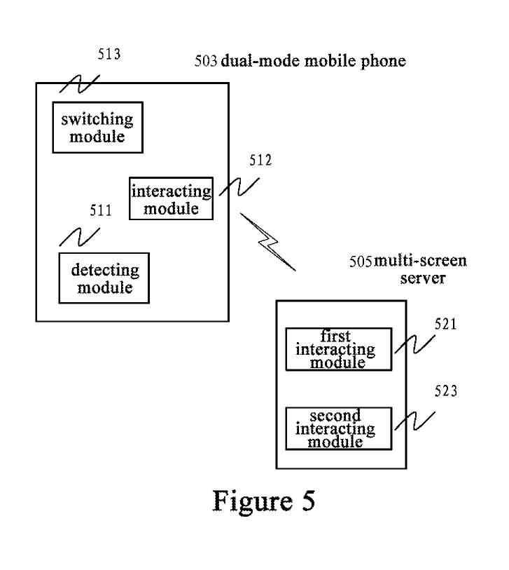

FIG. 5 shows a schematic structural diagram of a dual-mode mobile phone 503 and a multi-screen server 505 according to the embodiment of the present invention.

The dual-mode mobile phone 503 connected to the digital broadcasting TV network and cellular mobile communication network includes a detecting module 511 and a switching module 513. When receiving common-definition video content through the digital broadcasting TV network, the module 511 detects the presence of another display with valid Wi-Fi connection. If having detected the presence of another display with valid Wi-Fi connection such as TV, the module 513 switches the common-definition video content to a high-definition version of the video content and plays and presents it on the another display such as TV. Of course, if the video content being broadcasted in the digital broadcasting TV network has only one video definition, then, the dual-mode mobile phone may also switch the video directly to another display for play.

According to the embodiment of the invention, the detecting module 511 is further configured to detect the presence of another display with one of HDMI, Bluetooth, wireless USB connections. If so, the switching module 513 switches the video content to another suitable display for playback and presentation.

The dual-mode mobile phone 503 according to a preferred embodiment of the present invention further includes an interacting module 512 interacting with the first interacting module 521 and second interacting module 523 included by the multi-screen server.

In one embodiment, the module 512 sends a multi-screen bookmark associated with the watched video content to the multi-screen server 505 via the cellular mobile communication network, the multi-screen bookmark including channel number, bookmark time, user identification and other relevant information. The first interacting module 521 receives the multi-screen bookmark sent by the dual-mode mobile phone via the cellular mobile communication network, the multi-screen bookmark including channel number, bookmark time, user identification and other relevant information. According to the embodiment of the present invention, the module 521 can send a reminding message or an inquiring message to the dual-mode mobile phone 503 for indicating re-playing time of the rest of the video content on the digital broadcasting TV network or the IPTV network or for inquiring which kind of terminal the multi-screen user will select to watch the rest of the video content. The interacting module 512 of the dual-mode mobile phone 503 receives the reminding message or inquiring message from the multi-screen server 505 so as to know the re-playing time of the rest of the video content on the digital broadcasting TV network or the IPTV network, or feeds back to the multi-screen server 505 which kind of terminal to select to watch the rest of the video content.

In another embodiment of the present invention, the interacting module 512 of the dual-mode mobile phone 503 sends a command to the multi-screen server 505 of recording digital broadcasting TV video content or IPTV digital broadcasting TV video content in order to set and inform beginning-time and end-time of recording the digital broadcasting TV or IPTV video content. The second interacting module 523 of the multi-screen server 505 receives a command from the mobile phone 503 of recording digital broadcasting TV video content in order to set and inform beginning-time and end-time of recording the digital broadcasting TV or IPTV video content.

Using the mechanism provided by the invention, operators of the broadcasting and television network (such as operator of CMMB) can implement basic functions of a multi-screen system, and greatly expand a multi-screen service platform. When double-mode mobile phones use only broadcasting and television frequency bands to receive video data, apparently, wireless spectral resources of the cellular mobile communication network will be greatly saved. In addition, for a multi-screen user, the use of a dual-mode digital broadcasting TV handheld terminal will effectively save high costs caused in watching video the form of cell-phone (using wireless spectral resources of the cellular mobile communication network to establish a wireless connection). Furthermore, using the dual mode cell-phone of the present invention acting as a broadcasting and television signal receiver of a bigger-screen display via a Wi-Fi wireless connection, higher-definition video content may be presented and played on the bigger-screen display anywhere. This will bring QoE similar to IPTV to the digital broadcasting TV handheld terminal.

All kinds of elements or modules shown in the drawings or described here may be implemented as hardware, software, firmware, or some combination thereof. Moreover, one element or module may be implemented a command executable by a processor or computer to perform the function of the element. Some examples of the command include software, program code and firmware. When executed by the processor, the command may be run to guide the processor to execute the element function. The command may be stored in a storage device readable by the processor. Some examples of the storage device include a digital or solid state memory, magnetic storage medium such as disk and tape, hard disk or optical readable digital data storage medium.

Although particular embodiments are described, the scope of the present invention is not limited to these particular embodiments. The scope of the present invention is defined by the following claims and any equivalent forms thereof.

1. A mobile phone used in a multi-screen service system comprising a digital broadcasting TV network and a cellular mobile communication network, the mobile phone is connected to the digital broadcasting TV network and the cellular mobile communication network, said mobile phone comprises:
detecting module, configured to detect if there is another display with valid connection, when receiving common definition video content through the digital broadcasting TV network or the cellular mobile communication network; and
switching module, in case another display with a valid connection is detected,
configured to switch said common definition video to a higher definition video having the same video content if the higher definition video corresponding to the common definition video exists and play the higher definition version of the video content on said another display, and
configured to play said common definition video on said another display if on higher definition video corresponding to the common definition video exists.

2. The mobile phone according to claim 1, wherein the valid connection is one of Wi-Fi connection, High Definition Multimedia Interface HDMI cable connection, Bluetooth connection, wireless USB connection.

3. The mobile phone according to claim 1, wherein the multi-screen service system comprises a multi-screen server and the mobile phone further comprises an interacting module configured to send a multi-screen bookmark associated with the video content being watched through the cellular mobile communication network.

4. The mobile phone according to claim 3, wherein the interacting module is further configured to receive an inquire message for inquiring on which kind of terminal the multi-screen user having the mobile phone wants to watch the rest of the video content.

5. The mobile phone according to claim 4, wherein the multi-screen service system further comprises an IPTV network, the interacting module is further configured to receive a reminding message for reminding re-playing time of the rest of the video content on the digital broadcasting TV network or the IPTV network.

6. The mobile phone according to claim 1, wherein the multi-screen service system comprises a multi-screen server and an IPTV network, the mobile phone further comprises an interacting module configured to send a command to the multi-screen server of recording a digital broadcasting TV video or an IPTV network video content, in order to set and inform beginning-time and end-time of recording a digital broadcasting TV video or the IPTV network video content.

7. A method for operating multi-screen services by a mobile phone in a multi-screen service system comprising a digital broadcasting TV network and a cellular mobile communication network, the mobile phone is connected to the digital broadcasting TV network and the cellular mobile communication network, said method comprises:
detecting if there is another display with valid connection when receiving common definition video content through the digital broadcasting TV network or the cellular mobile communication network; and
in case another display with a valid connection is detected,
switching said common definition video to a higher definition video having the same video content if the higher definition video corresponding to the common definition video exists and playing the higher definition version of the video content on said another display, and
playing said common definition video on said another display if no higher definition video corresponding to the common definition video exists.

8. The method according to claim 7, wherein the valid connection is one of Wi-Fi connection, High Definition Multimedia Interface HDMI cable connection, Bluetooth connection, wireless USB connection.

9. The method according to claim 7, wherein the multi-screen service system comprises a multi-screen server and the method further comprises sending a Multi-screen Bookmark associated with the video content being watched through the cellular mobile communication network.

10. The method according to claim 10, further comprising receiving an inquire message for inquiring on which kind of terminal the multi-screen user having the mobile phone wants to watch the rest of the video content.

11. The method according to claim 10, wherein the multi-screen service system further comprises an IPTV network, the method further comprises receiving a reminding message for reminding re-playing time of the rest of the video content on the digital broadcasting TV network or the IPTV network.

12. The method according to claim 7, wherein the multi-screen service system comprises a multi-screen server and an IPTV network, the method further comprises sending a command to the multi-screen server of recording a digital broadcasting TV video or an IPTV network video content, in order to set and inform beginning-time and end-time of recording a digital broadcasting TV video or the IPTV network video content.

13. A multi-screen server for serving a mobile phone in a multi-screen service system comprising a digital broadcasting TV network, a cellular mobile communication network and an IPTV network, the mobile phone is connected to the digital broadcasting TV network and the cellular mobile communication network, said multi-screen server comprises:
first interacting module, configured to send a reminding or inquiring message when receiving a multi-screen bookmark sent by the mobile phone and associated with the video content being watched through the cellular mobile communication network, to indicate the re-playing time of the rest of the video content on the digital broadcasting TV network or the IPTV network or to inquire on which kind of terminal the multi-screen user having the mobile phone wants to watch the rest of the video content; and
second interacting module, configured to receive a command from the mobile phone of recording a digital broadcasting TV video or an IPTV network video content, for setting and informing beginning-time and end-time of recording a digital broadcasting TV video or the IPTV network video content.
